(19) United States
(12) Patent Application Publication
(10) Pub. No.: US 2024/0423115 A1
(43) Pub. Date: Dec. 26, 2024

(54) ROW PLANTING UNIT AND METHOD OF USE

(71) Applicant: G.B.G.I., Inc., Chardon, OH (US)

(72) Inventors: William CARRICK, Chardon, OH (US); Peter T. CASAMENTO, Solon, OH (US)

(73) Assignee: G.B.G.I., Inc., Chardon, OH (US)

(21) Appl. No.: 18/340,204

(22) Filed: Jun. 23, 2023

(51) Int. Cl. A01C 7/20; A01B 63/00; A01C 5/06

(52) U.S. Cl. CPC A01C 7/203; A01B 63/008; A01C 5/064

(57) ABSTRACT

A row planting unit that includes a lower shank, a head frame that operably engages with the lower shank, a pair of upper planting arms that pivotably engages with the head frame, and a lower planting arm that pivotably engages with the head frame and is adapted to operably engaged with an actuating device. Each of the lower shank, the head frame, the pair of upper planting arms, and the lower planting arm is casted from a single metal material.

### TECHNICAL FIELD

This disclosure is directed to a row planting unit for a planter or seeding machine.

### BACKGROUND ART

In current farming operations, row unit planters or row crop planters are generally used to plant seeds in wider rows than other conventional farming implements such as grain drills. Generally, these planters include various components and attachments for planting seeds, including a hopper, a metering unit, a seed tube, a furrow opener, opening blades, and closing or press wheels. However, throughout one or more planting seasons, various parts and components of these row units become worn and damaged due to various reasons, including continuous movement and articulation when traversing over uneven terrain, dirt and other debris that is kicked up against these components during planting operations, and continuous contact with various types of grain and chemicals.

To combat against these issues, farmers and operators of these machines may simply repair these machines by fixing and/or replacing worn or damaged parts of these machines. However, such replacement of these parts may be difficult for various reasons. In one example, replacing particular parts and/or components of a row unit may not be readily available to the farmer or operator of these machines due to the age of the row unit. In this instance, the farmer or operator of these machines may not be able to simply replace the part or component since these available parts are unavailable and/or no longer produced. In another instance, replacing particular parts and/or components of row unit may not be readily available to the farmer or operator of these machines due to the components now included and/or retrofitted on the row unit. In this instance, the farmer or operator may need to remove and replace not only the worn or damaged part but also other various parts and components that are engaged with this worn or damaged parts; as such, this may cause the farmer or operator of these machines to incur greater costs and labor in order to resolve this issue. In yet another instance, replacing particular parts and/or components of row unit may not be readily available to the farmer or operator of these machines due to the overall compatibility of these new parts and components with the worn, preexisting parts and components.

### SUMMARY OF THE INVENTION

In one aspect, an exemplary embodiment of the present disclosure may provide a row planting unit. The row planting unit includes a lower shank. The row planting unit also includes a head frame that operably engages with the lower shank. The row planting unit also includes a pair of upper planting arms that pivotably engages with the head frame. The row planting unit also includes a lower planting arm that pivotably engages with the head frame and is adapted to operably engaged with an actuating device. Each of the lower shank, the head frame, the pair of upper planting arms, and the lower planting arm is casted from a single metal material.

This exemplary embodiment or another exemplary embodiment further includes that the lower shank comprises: a main body having a first end and a second end longitudinally opposite to the first end; wherein a portion of the main body defines a substantially triangular cross-section between the first end and the second end. This exemplary embodiment or another exemplary embodiment further includes that the main body further comprises: at least one pair of inner walls extending between the first end and the second end and defined at a first angle measured between each inner wall of the at least one pair of inner walls; and at least one pair of outer walls extending between the first end and the second end and defined at a second angle measured between each outer wall of the at least one pair of outer walls. This exemplary embodiment or another exemplary embodiment further includes that the at least one pair of inner walls and the at least one pair of outer walls collectively defines a first portion of the substantially triangular cross-section. This exemplary embodiment or another exemplary embodiment further includes that the main body further comprises: at least another pair of inner walls extending between the first end and the second end and defined at a third angle measured between each inner wall of the at least another pair of inner walls; and at least another pair of outer walls extending between the first end and the second end and defined at a fourth angle measured between each outer wall of the at least another pair of outer walls; wherein the first angle is greater than the third angle and the second angle is greater than the fourth angle. This exemplary embodiment or another exemplary embodiment further includes that the at least another pair of inner walls and the at least another pair of outer walls collectively defines a second portion of the substantially triangular cross-section. This exemplary embodiment or another exemplary embodiment further includes that the lower shank further comprises: a first end; a second end longitudinally opposite to the first end; and at least one cable support operably engaged with the lower shank; wherein the at least one cable support is configured to support at least one cable of the row planting unit free from interfering with the lower shank. This exemplary embodiment or another exemplary embodiment further includes that the at least one cable support comprises: a first end; a second end longitudinally opposite to the first end; an inner side operably engaged with the lower shank; and at least one attachment point defined in the at least one cable support between the first end and the second end; wherein the at least one attachment point enables at least one cable of the row planting unit to be supported by the at least one cable support. This exemplary embodiment or another exemplary embodiment further includes at least one fastener operably engaging the at least one cable with the at least one cable support at the at least one attachment point. This exemplary embodiment or another exemplary embodiment further includes at least another cable support operably engaged with the lower shank transversely opposite to the at least one cable support; wherein the at least another cable support is configured to support at least another cable of the row planting unit free from interfering with the lower shank. This exemplary embodiment or another exemplary embodiment further includes that the lower shank comprises: a first end; a second end longitudinally opposite to the first end; and a mounting portion positioned at the second end and having a substantially triangular-shape configuration. This exemplary embodiment or another exemplary embodiment further includes that the head frame comprises: a first end; a second end transversely opposite to the first end; and a mounting surface positioned between the first end and the second end along a base wall inside of a recess defined in the head frame and configured to operably engaged with the mounting portion; wherein the mounting surface has a substantially triangular-shape configuration matching the mounting portion. This exemplary embodiment or another exemplary embodiment further includes that the lower shank further comprises: a first projection of the mounting portion extending outwardly from the second end of the lower shank and engaging with the head frame; and a second projection of the mounting portion extending outwardly from the second end of the lower shank and engaging with the head frame; wherein the first projection and second projection directly oppose one another to define the substantially triangular-shape configuration. This exemplary embodiment or another exemplary embodiment further includes that the head frame further comprises: a first section of the mounting surface that is configured to operably engage with the first projection; and a second section of the mounting surface from the first section and is configured to operably engage with the second projection; wherein the first section and second section directly oppose one another to define a substantially triangular-shape configuration for the mounting surface that matches the substantially triangular-shape configuration of the mounting portion. This exemplary embodiment or another exemplary embodiment further includes a mounting bracket operably engaged with the pair of upper planting arms and the lower planting arm. This exemplary embodiment or another exemplary embodiment further includes a leg of the lower shank; and a pair of opening disks rotatably engaged with the leg of the lower shank; wherein the leg operably engages each opening disk of the pair of opening disks at an angle of about 12 degrees. This exemplary embodiment or another exemplary embodiment further includes a pair of gauge wheel arm assemblies operably engaging with the lower shank, each gauge wheel arm assembly comprises: an arm portion; and a hub portion operably engaged with the arm portion for receiving at least two bearings that are spaced apart from one another by at least two stop portions. This exemplary embodiment or another exemplary embodiment further includes that the lower planting arm comprises: a first linkage arm; a second linkage arm parallel with the first linkage arm; a first bracket fixedly engaging with the first linkage arm and the second linkage arm at a first position; and a second bracket fixedly engaging with the first linkage arm and the second linkage arm at a second position opposite to the first position; wherein each of the first bracket and the second bracket is adapted to operably engage with an actuating device of the row unit. This exemplary embodiment or another exemplary embodiment further includes that the lower planting arm further comprises: a first mount extending outwardly from the first bracket; and a second mount extending outwardly from the second bracket and directly facing the first mount; wherein each of the first mount and the second mount is adapted to operably engage with the actuating device of the row unit.

In another aspect, an exemplary embodiment of the present disclosure may provide a row planting unit. The row planting unit includes a lower shank that has a main body that includes a first end and a second end longitudinally opposite to the first end, wherein a portion of the main body defines a substantially triangular cross-section between the first end and the second end. The row planting unit also includes a head frame that operably engages with the lower shank. The row planting unit also includes a pair of upper planting arms that pivotably engages with the head frame. The row planting unit also includes a lower planting arm that pivotably engages with the head frame and is adapted to operably engaged with an actuating device. Each of the lower shank, the head frame, the pair of upper planting arms, and the lower planting arm is casted from a single metal material.

In yet another aspect, an exemplary embodiment of the present disclosure may provide a lower shank of a row planting unit. The lower shank includes a first end, a second end longitudinally opposite to the first end, and at least one cable support operably engaged with the lower shank. The at least one cable support is configured to support at least one cable of the row planting unit free from interfering with the lower shank.

This exemplary embodiment or another exemplary embodiment further includes an outer wall extending between the first end and the second end; and an inner wall extending between the first end and the second end and facing in an opposite direction relative to the outer wall; wherein the at least one cable support operably engages with the outer wall and is spaced apart from the inner wall. This exemplary embodiment or another exemplary embodiment further includes a passage defined by the inner wall that extends vertically between a top surface of the lower shank and a bottom surface of the lower shank; wherein the at least one cable support is positioned external to the passage. This exemplary embodiment or another exemplary embodiment further includes that the at least one cable support comprises: a first end; a second end longitudinally opposite to the first end; an inner side operably engaged with the lower shank; and at least one attachment point defined in the at least one cable support between the first end and the second end; wherein the at least one attachment point enables at least one cable of the row planting unit to be supported by the at least one cable support. This exemplary embodiment or another exemplary embodiment further includes at least one fastener operably engaging the at least one cable with the at least one cable support at the at least one attachment point. This exemplary embodiment or another exemplary embodiment further includes that the at least one cable support further comprises: an outer side transversely opposite to the inner side and spaced apart from the lower shank; and at least one notch defined at the outer side and aligned with the at least one attachment point; wherein the at least one fastener operably engages the at least one cable with the at least one cable support at the at least one attachment point and the at least one notch. This exemplary embodiment or another exemplary embodiment further includes that the at least one cable support comprises: a first end; a second end longitudinally opposite to the first end; an inner side operably engaged with the lower shank; and at least one attachment point defined at the inner side proximate to the first end; wherein the at least one attachment point enables at least one cable of the row planting unit to be supported by the at least one cable support. This exemplary embodiment or another exemplary embodiment further includes that the at least one cable support further comprises: at least another attachment point defined at the inner side proximate to the second end and is longitudinally opposite to the at least one attachment point; wherein one or both of the at least one attachment point and the at least another attachment point enable the at least one cable of the row planting unit to be supported by the at least one cable support. This exemplary embodiment or another exemplary embodiment further includes at least one fastener operably engaging the at least one cable with the at least one cable support at the at least one attachment point; and at least another fastener operably engaging the at least one cable with the at least one cable support at the at least another attachment point. This exemplary embodiment or another exemplary embodiment further includes that the at least one cable support further comprises: an outer side transversely opposite to the inner side and spaced apart from the lower shank; at least one notch defined at the outer side and aligned with the at least one attachment point; and at least another notch defined at the outer side and aligned with the at least another attachment point; wherein the at least one fastener and the at least another fastener operably engages the at least one cable with the at least one cable support at the at least one attachment point and the at least one notch and at the at least another attachment point and the at least another notch. This exemplary embodiment or another exemplary embodiment further includes an upper engagement wall extending between the first end and the second end and positioned at a top end of the lower shank; wherein the at least one cable support is offset from the upper engagement wall. This exemplary embodiment or another exemplary embodiment further includes at least another cable support operably engaged with the lower shank; wherein the at least another cable support is configured to support at least another cable of the row planting unit free from interfering with the lower shank. This exemplary embodiment or another exemplary embodiment further includes that the at least another cable support operably engages with outer wall of the lower shank and is positioned transversely opposite to the at least one cable support. This exemplary embodiment or another exemplary embodiment further includes an upper engagement wall extending between the first end and the second end and positioned at a top end of the lower shank; wherein each of the at least one cable support and the at least another cable support is offset from the upper engagement wall.

In yet another aspect, an exemplary embodiment of the present disclosure may provide a method of securing at least one cable of a row planting unit. The method comprises steps of introducing the at least one cable to a lower shank of the row planting unit; routing the at least one cable to at least one cable support of the lower shank, wherein the at least one cable is spaced apart from a passage defined inside of the lower shank; and securing the at least one cable at one attachment point of the at least one cable support.

This exemplary embodiment or another exemplary embodiment further includes that the step of securing the at least one cable further comprises: inserting the at least one cable through the one attachment point. This exemplary embodiment or another exemplary embodiment further includes that the step of securing the at least one cable further comprises: inserting at least one fastener through the one attachment point; and mounting the at least one cable, via the at least one fastener, with the at least one cable support at the one attachment point. This exemplary embodiment or another exemplary embodiment further includes that the step of securing the at least one cable further comprises: inserting the at least one cable through the one attachment point; and inserting the at least one cable through another attachment point of the at least one cable support. This exemplary embodiment or another exemplary embodiment further includes that the step of securing the at least one cable further comprises: inserting at least one fastener through the one attachment point; inserting at least another fastener through the another attachment point; mounting the at least one cable, via the at least one fastener, with the at least one cable support at the one attachment point; and mounting the at least one cable, via the at least another fastener, with the at least one cable support at the another attachment point. This exemplary embodiment or another exemplary embodiment further includes steps of introducing at least another cable to the lower shank of the row planting unit; routing the at least another cable to at least another cable support of the lower shank, wherein the at least one cable is spaced apart from the passage defined inside of the lower shank and transversely opposite to the at least one cable support; and securing the at least another cable at one attachment point of the at least another cable support.

In yet another aspect, an exemplary embodiment of the present disclosure may provide a lower shank of a row planting unit. The lower shank includes a main body that has a first end and a second end longitudinally opposite to the first end. The lower shank also includes a leg that operably engages with the main body and extends downwardly from the second end of the main body. The lower shank also includes a mounting portion that operably engages with the main body and extends outwardly from the second end of the main body. The lower shank also includes that a portion of the main body defines a substantially triangular cross-section between the first end and the second end.

This exemplary embodiment or another exemplary embodiment further includes that the main body further comprises: at least one pair of inner walls extending between the first end and the second end and defined at a first angle measured between each inner wall of the at least one pair of inner walls; and at least one pair of outer walls extending between the first end and the second end and defined at a second angle measured between each outer wall of the at least one pair of outer walls. This exemplary embodiment or another exemplary embodiment further includes that the at least one pair of inner walls and the at least one pair of outer walls collectively defines a first portion of the substantially triangular cross-section. This exemplary embodiment or another exemplary embodiment further includes that the main body further comprises: at least another pair of inner walls extending between the first end and the second end and defined at a third angle measured between each inner wall of the at least another pair of inner walls; and at least another pair of outer walls extending between the first end and the second end and defined at a fourth angle measured between each outer wall of the at least another pair of outer walls; wherein the first angle is greater than the third angle and the second angle is greater than the fourth angle. This exemplary embodiment or another exemplary embodiment further includes that the at least another pair of inner walls and the at least another pair of outer walls collectively defines a second portion of the substantially triangular cross-section. This exemplary embodiment or another exemplary embodiment further includes that each of the first angle and the second angle is about 16 degrees. This exemplary embodiment or another exemplary embodiment further includes that each of the third angle and the fourth angle is about 7.5 degrees. This exemplary embodiment or another exemplary embodiment further includes that the leg comprises: a top end and a bottom end vertically opposite to the top end; a vertical axis defined between the top end and the bottom end; a first lateral support extending between the top end and the bottom end at a first angle measured relative to the vertical axis; and a first securement member extending outwardly from the first lateral support at a second angle measured relative to the vertical axis; wherein the second angle is greater than the first angle. This exemplary embodiment or another exemplary embodiment further includes that the leg further comprises: a second lateral support extending between the top end and the bottom end at a third angle measured relative to the vertical axis; and a second securement member extending outwardly from the second lateral support at a fourth angle measured relative to the vertical axis; wherein the fourth angle is greater than the third angle. This exemplary embodiment or another exemplary embodiment further includes that the first angle and the third angle are equal to one another; and wherein the second angle and the fourth angle are equal to one another. This exemplary embodiment or another exemplary embodiment further includes that each of the first angle and the third angle is about 7.5 degrees. This exemplary embodiment or another exemplary embodiment further includes that each of the second angle and the fourth angle is about 12 degrees. This exemplary embodiment or another exemplary embodiment further includes that the leg further comprises: a first threaded opening defined by the first securement member at the second angle; wherein the first threaded opening is adapted to threadably engage with a first opening disk of the row planting unit at the second angle. This exemplary embodiment or another exemplary embodiment further includes that the leg further comprises: a second threaded opening defined by the second securement member at the fourth angle; and wherein the second threaded opening is adapted to threadably engage with a second opening disk of the row planting unit at the fourth angle. This exemplary embodiment or another exemplary embodiment further includes that the mounting portion comprises: a first projection extending outwardly from an intermediate section of the mounting portion at the second end of the lower shank; and a second projection extending outwardly from the intermediate section of the mounting portion at the second end of the lower shank; wherein the first projection and second projection directly oppose one another to collectively define a substantially triangular-shaped configuration. This exemplary embodiment or another exemplary embodiment further includes that the mounting portion further comprises: a set of first threaded openings defined in the first projection; and a set of second threaded openings defined in the second projection; wherein the set of first threaded openings and the set of second threaded openings are adapted to threadably engage with a set of fasteners for operably engaging the lower shank and a head frame of the row planting unit with one another. This exemplary embodiment or another exemplary embodiment further includes that each threaded opening of the set of first threaded openings is offset from one another; and wherein each threaded opening of the set of second threaded openings is offset from one another. This exemplary embodiment or another exemplary embodiment further includes that the mounting portion further comprises: at least one threaded opening defined in the intermediate section and offset from the set of first threaded openings and the set of second threaded openings; wherein the at least one threaded opening is adapted to threadably engage with at least one fastener of the set of fasteners for operably engaging the lower shank and the head frame with one another. This exemplary embodiment or another exemplary embodiment further includes at least one cable support operably engaged with the lower shank; wherein the at least one cable support is configured to support at least one cable of the row planting unit free from interfering with the lower shank.

In yet another aspect, an exemplary embodiment of the present disclosure may provide a method. The method comprises steps of providing a lower shank of a row planting unit, the lower shank comprises: a main body having a first end and a second end longitudinally opposite to the first end; a leg operably engaged with the main body and extending downwardly from the second end of the main body; and a mounting portion operably engaged with the main body and extending outwardly from the second end of the main body; wherein a portion of the main body defines a substantially triangular cross-section between the first end and the second end; engaging a pair of opening disks of the row planting unit with the leg; and engaging a head frame of the row planting unit with the mounting portion.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top, rear, right side isometric perspective view of a row unit in accordance with one aspect of the present disclosure.

FIG. 2 is a right side elevation view of the row unit shown in FIG. 1.

FIG. 3 is a top plan view of the row unit shown in FIG. 1.

FIG. 4 is a partial cross-sectional view of a lower shank of the row unit taken in the direction of line 4-4 shown in FIG. 2.

FIG. 5A is a top, rear, right side isometric perspective view of the lower shank of the row unit.

FIG. 5B is a top, rear, right side isometric perspective view of the lower shank of the row unit.

FIG. 6 is a right side elevation view of the lower shank shown in FIG. 5.

FIG. 7 is a front elevation view of the lower shank shown in FIG. 5.

FIG. 8A is a partial cross-sectional view of the lower shank taken in the direction of line 8A-8A in FIG. 6.

FIG. 8B is a partial cross-sectional view of the lower shank taken in the direction of line 8B-8B in FIG. 6.

FIG. 9 is a top, rear, right side isometric perspective view of a head frame of the row unit.

FIG. 10 is a rear elevation view of the head frame shown in FIG. 9.

FIG. 11 is a front elevation view of the head frame shown in FIG. 9.

FIG. 12 is an enlargement of the highlighted region in FIG. 1.

FIG. 13 is an exploded view of a mounting plate and an actuator bracket of the row unit.

Similar numbers refer to similar parts throughout the drawings.

### DETAILED DESCRIPTION

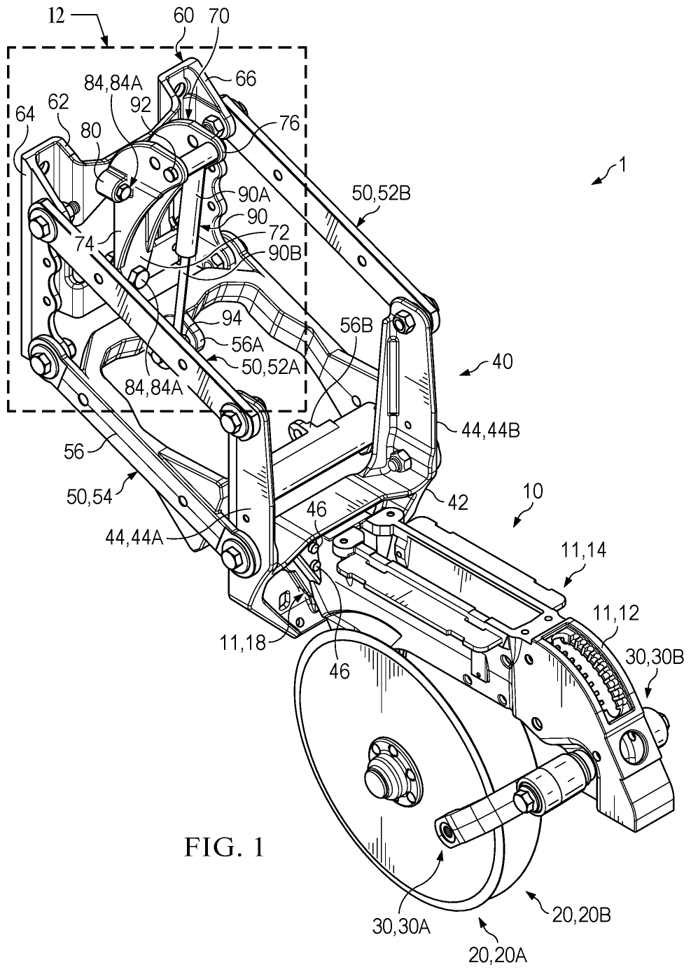

FIG. 1 illustrates a planter row unit or row planting unit (hereinafter as “row unit”) generally referred to as 1. Row unit 1 is adapted to be mounted to a planter or seeding machine and is generally used to plant seeds in wider rows than other conventional farming implements. As described in greater detail below, row unit 1 include various components and attachments for planting seeds.

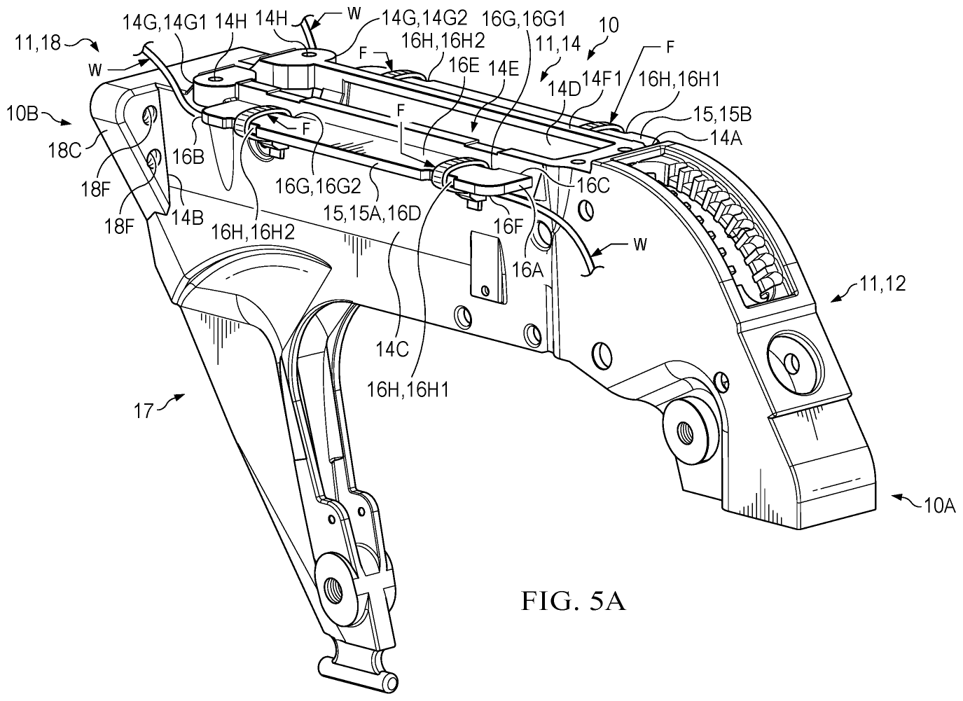

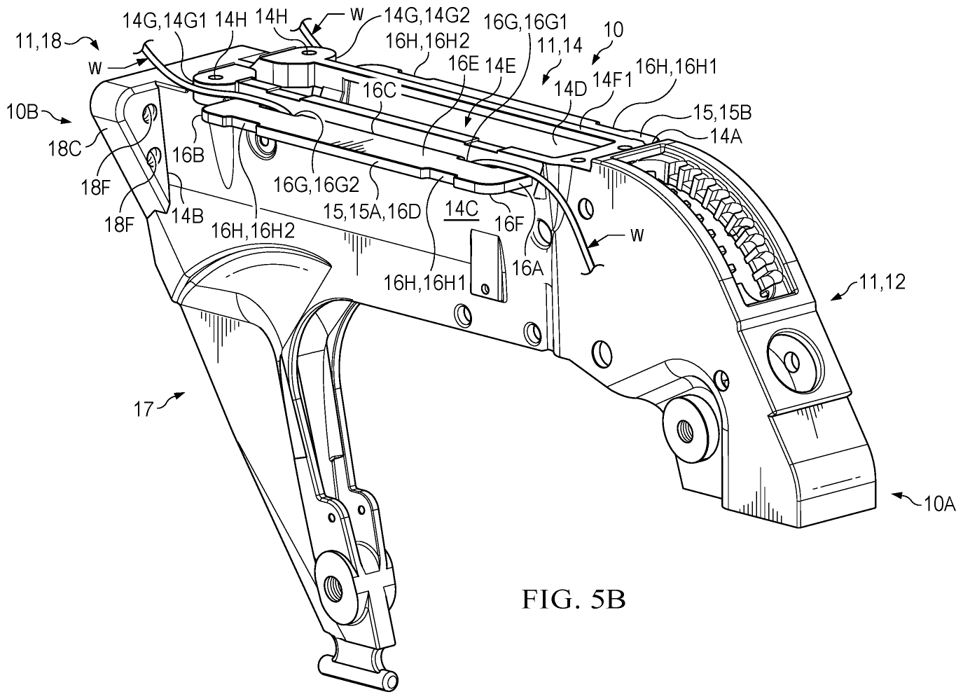

Row unit 1 includes a lower shank 10. As best seen in FIG. 5A, lower shank 10 includes a first main end 10A, a second main end 10B longitudinally opposite to the first main end 10A, and a longitudinal axis defined between. Lower shank 10 includes a main body 11 that has a depth adjustment portion 12 that extends longitudinally from the first main end 10A towards the second main end 10B. In the present disclosure, depth adjustment portion 12 is configured to operably engage with depth adjustment assemblies (not illustrated herein) wherein the depth adjustment assemblies may set a desired depth for a closing or furrow system during a planting operation.

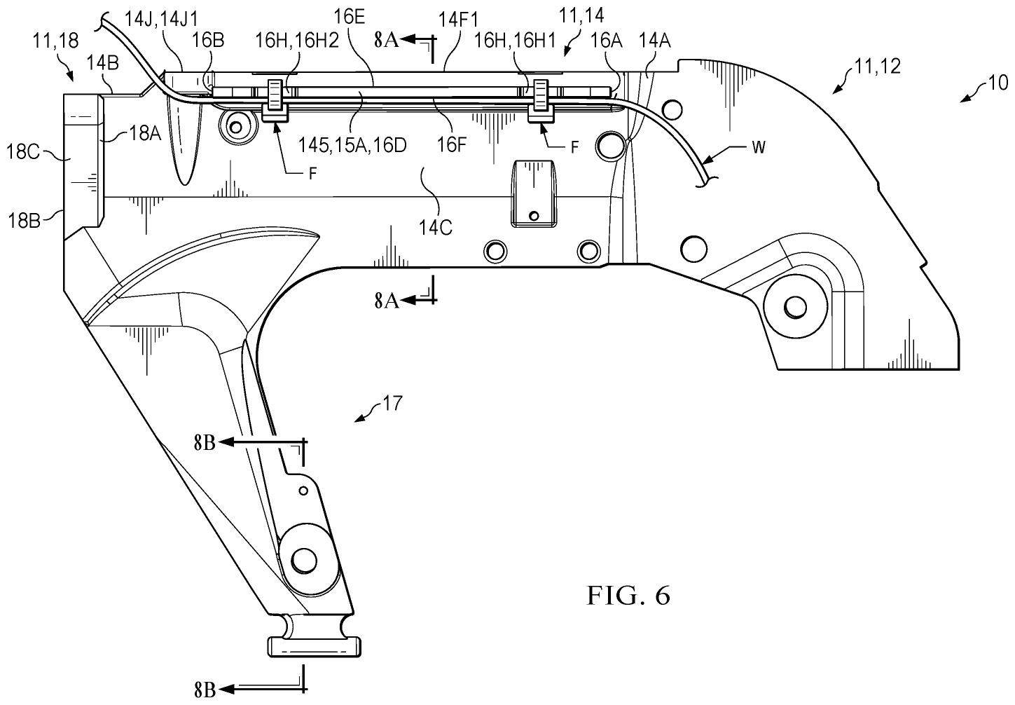

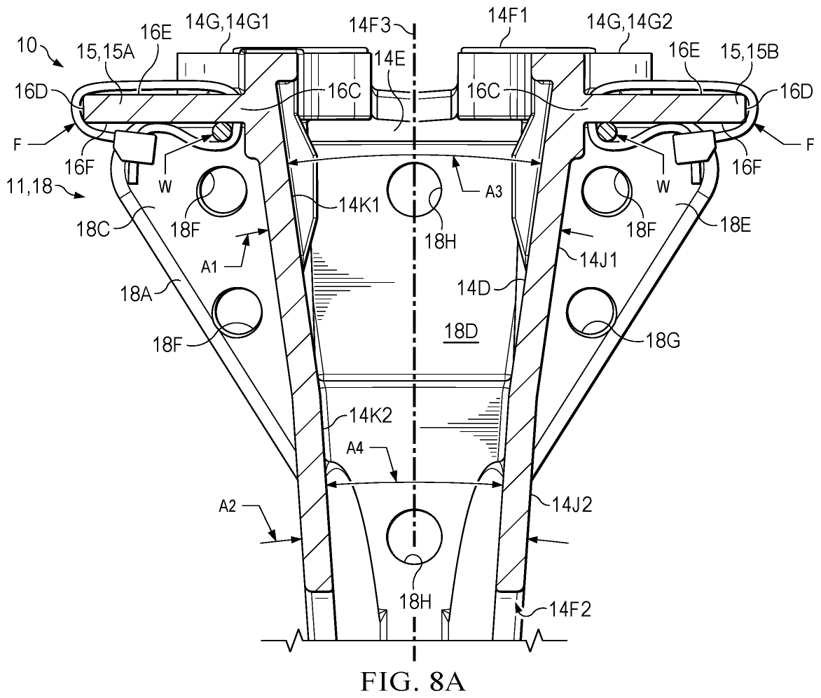

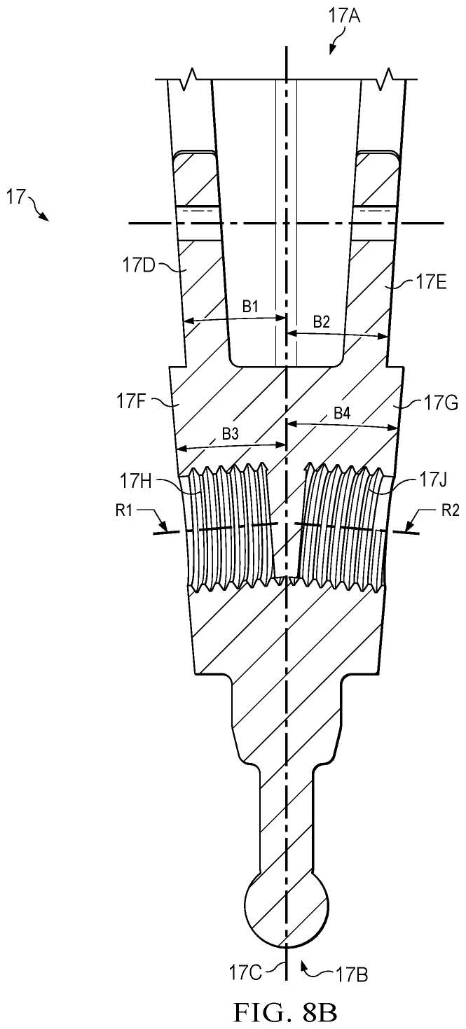

Main body 11 also includes an intermediate portion 14 that extends longitudinally from the depth adjustment portion 12 towards the second main end 10B of lower shank 10. As best seen in FIGS. 5A-6, intermediate portion 14 includes a first end 14A that is positioned near the depth adjustment portion 12, a second end 14B longitudinally opposite to the first end 14A, and a longitudinal axis defined therebetween. Intermediate portion 14 also includes an outer wall 14C that extends longitudinally between the first end 14A and the second end 14B and is in communication with the exterior environment of the lower shank 10 (see FIGS. 5A and 8). Intermediate portion 14 also includes an inner wall 14D that extends longitudinally between the first end 14A and the second end 14B and is in fluid communication with the exterior environment of the lower shank 10 by a passage 14E defined in intermediate portion 14 (see FIG. 8).

In the present disclosure, intermediate portion 14 defines a triangular-shaped cross-section and/or substantially V-shaped cross section when viewed from a cross-sectional view (see FIG. 8). As best seen in FIG. 8, the outer wall 14C and the inner wall 14D of the intermediate portion 14 collectively define a triangular-shaped cross-section for lower shank 10 when viewed from a front elevation view. In the present disclosure, the triangular-shaped cross-section of the intermediate portion 14 is defined along the entire length of the intermediate portion 14 between the first end 14A and the second end 14B. In one exemplary embodiment, triangular-shaped cross-section may also be formed in the depth adjustment portion 12 and other parts of the lower shank 10. Such inclusion of the triangular-shaped in the intermediate portion 14 of the lower shank 10 may provide greater strength along the length of the intermediate portion 14 when carrying various planting and/or seeding devices while narrowing the overall footprint and/or size of the lower shank 10.

Intermediate portion 14 of lower shank 10 also includes an upper engagement wall 14F1. As best seen in FIG. 5A, upper engagement wall 14F1 extends longitudinally between the first end 14A and the second end 14B where the upper engagement wall 14F1 is substantially flat and/or planar. While not illustrated herein, various planting attachments and/or devices, such as seed hoppers, seed meters, and other planting attachment of the like, are secured to the upper engagement wall 14F1. Intermediate portion 14 also includes a bottom end 14F2 vertically opposite to the upper engagement wall 14F1. Intermediate portion 14 also includes a vertical axis 14F3 that extends vertically between the upper engagement wall 14F1 and the bottom end 14F2 (see FIG. 8A).

Intermediate portion 14 of lower shank 10 also includes at least one extension 14G. As best seen in FIG. 5A, intermediate portion 14 includes a first extension 14G1 that extends outwardly in a first direction from the intermediate portion 14 at the second end 14B of intermediate portion 14. Similarly, intermediate portion 14 includes a second extension 14G2 that extends outwardly in a second direction (opposite to the first direction of the first extension 14G1) from the intermediate portion 14 at the second end 14B of intermediate portion 14. Each of the first extension 14G1 and the second extension 14G2 also defines an opening 14H that extends entirely through each of the first extension 14G1 and the second extension 14G2. In the present disclosure, each of the first extension 14G1 and the second extension 14G2 provides an attachment location for various planting or seeding components, including seed hoppers and other various planting or seeding components.

With respect to the outer wall 10C, outer wall 14C includes a first outer portion 14J1 that extends downwardly from the upper engagement wall 14F1 towards the bottom end 14F2 of the intermediate portion 14 at a first angle relative to the vertical axis 14F3; first angle is denoted be arrows labeled “A1” in FIG. 8A. In the present disclosure, the first angle of the first outer portion 14J1 is measured between two surfaces that transversely oppose one another of the first outer portion 14J1. Outer wall 14C also includes a second outer portion 14J2 that extends downwardly from the first outer portion 14J1 to the bottom end 14F2 of the intermediate portion 14 at a second angle relative to the vertical axis; second angle is denoted be arrows labeled “A2” in FIG. 8A. In the present disclosure, the second angle of the second outer portion 14J2 is measured between two surfaces that transversely oppose one another of the second outer portion 14J2. In the illustrated embodiment, the first angle “A1” of the first outer portion 14J1 is greater than the second angle “A2” of the second outer portion 14J2. In one exemplary embodiment, the first angle of the first outer portion 14J1 is about 16 degrees, and the second angle of the second outer portion 14J2 is about 7.5 degrees.

With respect to the inner wall 10D, inner wall 14D includes a first inner portion 14K1 that extends downwardly from the upper engagement wall 14F1 towards the bottom end 14F2 of the intermediate portion 14 at a third angle relative to the vertical axis 14F3; third angle is denoted be arrows labeled “A3” in FIG. 8A. In the present disclosure, the third angle of the first inner portion 14K1 is measured between two surfaces that transversely oppose one another of the first inner portion 14K1. Inner wall 14D also includes a second inner portion 14K2 that extends downwardly from the first inner portion 14K1 to the bottom end 14F2 of the intermediate portion 14 at a fourth angle relative to the vertical axis; fourth angle is denoted be arrows labeled “A4” in FIG. 8A. In the present disclosure, the fourth angle of the second inner portion 14K2 is measured between two surfaces that transversely oppose one another of the second inner portion 14K2. In the illustrated embodiment, the third angle “A3” of the first inner portion 14K1 is greater than the fourth angle “A4” of the second inner portion 14K2. In one exemplary embodiment, the third angle of the first inner portion 14K1 is about 16 degrees, and the fourth angle of the second inner portion 14K2 is about 7.5 degrees.

Main body also includes at least one support or cable support 15 that operably engages with and extends outwardly from the intermediate portion 14. As best seen in FIG. 5A, lower shank 10 includes a first cable support 15A that operably engages with and extends outwardly from the intermediate portion 14 in a first direction along an axis that is substantially perpendicular to the longitudinal axis of the intermediate portion 14. Still referring to FIG. 5A, lower shank 10 also includes a second cable support 15B that operably engages with and extends from the intermediate portion 14 in a second direction along an axis that is substantially perpendicular to the longitudinal axis of the intermediate portion 14; the second direction is also opposite to the first direction of the first cable support 15A. In the present disclosure, the first cable support 15A and the second cable support 15B are substantially similar to one another and are operably engaged with the intermediate portion 14 in a mirror-image orientation. Inasmuch as the first cable support 15A and second cable support 15B are substantially similar to one another, the following description will relate to the first cable support 15A for brevity. It should be understood, however, that while the first cable support 15A is described herein, the description of the first cable support 15A applies equally to the second cable support 15B.

In the present disclosure, first cable support 15A includes a first end 16A, and second end 16B longitudinally opposite to the first end 16A, and a longitudinal axis defined therebetween. As best seen in FIG. 5A, the first cable support 15A also has a length that is measured from the first end 16A to the second end 16B; the length of the first cable support 15A is less than the length of the intermediate portion 14.

First cable support 15A also includes an inner or first side 16C that extends between the first end 16A and the second end 16B and operably engages with the intermediate portion 14 (particularly the outer wall 14C of the intermediate portion 14). First cable support 15A also includes an outer or second side 16D that extends between the first end 16A and the second end 16B and faces away from the inner side 16C. In the present disclosure, the outer side 16D is spaced apart from the intermediate portion 14, particularly away from the outer wall 14C of the intermediate portion 14.

First cable support 15A also includes a top end 16E that is positioned vertically above the first end 16A, the second end 16B, the inner side 16C, and the outer side 16D. First cable support 15A also includes a bottom end 16F that is positioned vertically below the first end 16A, the second end 16B, the inner side 16C, and the outer side 16D and faces away from the top end 16E. In the present disclosure, the top end 16E of the first cable support 15A is positioned below and/or is offset from the upper engagement wall 14F1 of intermediate portion 14. As such, the top ends 16E of the first cable support 15A and the second cable support 15B lie on an imaginary horizontal plane that is below the upper engagement wall 14F1 of the intermediate portion 14. Such offset configuration may prevents the first cable support 15A and the second cable support 15B from interfering with planting parts or components operably engaged with the intermediate portion 14 at the upper engagement wall 14F1.

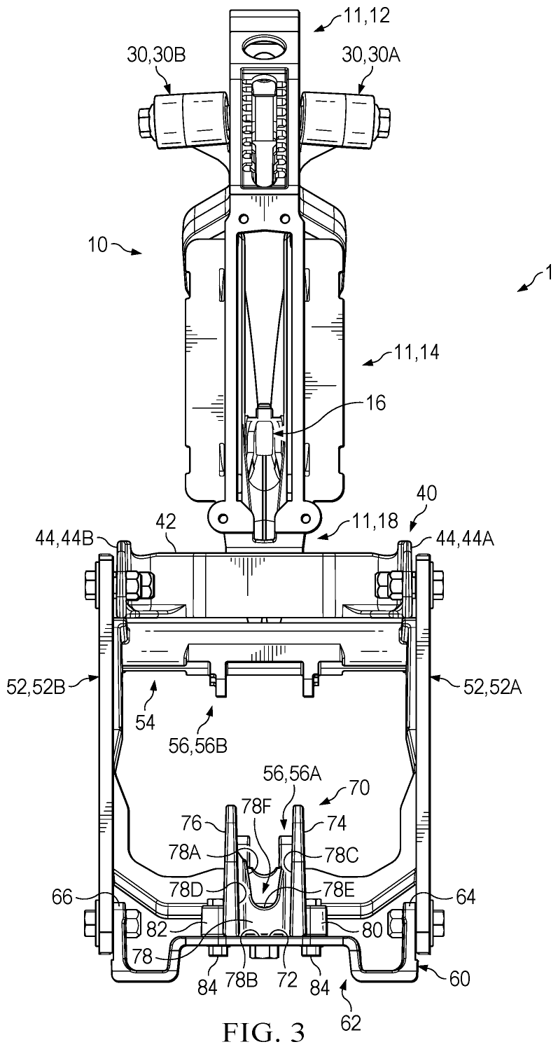

First cable support 15A may define at least one attachment opening 16G at the inner side 16C between the first end 16A and the second end 16B. As best seen in FIGS. 3 and 5A-5B, first cable support 15A defines a first attachment opening 16G1 at the inner side 16C of the first cable support 15A proximate to the first end 16A of the first cable support 15A. Still referring to FIGS. 3 and 5A-5B, first cable support 15A also defines a first attachment opening 16G1 at the inner side 16C of the first cable support 15A proximate to the second end 16B of the first cable support 15A. As best seen in FIG. 5A, one or both of the first attachment opening 16G1 and the second attachment opening 16G2 enables one or more fasteners “F” to pass through the first cable support 15A to secure and support one or more cables or wires “W” to the first cable support 15A (see FIGS. 5A and 8A). As best seen in FIG. 5A, the one or more cables or wires may be secured to the bottom end 16F of the first cable support 15A by the one or more fasteners external to the passage 14E defined in the intermediate portion 14. With such attachment capabilities, the first cable support 15A is configured to protect and/or shield the one or more wires or cables of the row unit 1 during planting operations.

In the present disclosure, the one or more fasteners “F” used to secure and support one or more cables or wires “W” to the first cable support 15A are cable zip ties or mounts. While cable zip ties or mounts are used herein, any preexisting or commercially-available fasteners and/or mounts may be used to secure and support one or more cables or wires “W” to the first cable support 15A. It should be appreciated that the one or more fasteners discussed and illustrated herein may be one of separate from the first cable support 15A or integrated with the first cable support 15A to secure and support one or more cables or wires “W” to the first cable support 15A.

While the one or more cables or wires “W” are secured and supported to the first cable support 15A by one or more fasteners passing through one or both of the first attachment opening 16G1 and the second attachment opening 16G2, the first cable support 15A may support and secure the one or more cables or wires “W” in other suitable configurations. As best seen in FIG. 5B, the one or more cables or wires “W” may pass through one or both of the first attachment opening 16G1 and the second attachment opening 16G2 where the one or more cables or wires “W” are supported solely by the first cable support 15A at one or both of the first attachment opening 16G1 and the second attachment opening 16G2. In one instance, the one or more cables or wires “W” may pass through the first attachment opening 16G1 at the top end 16E of the first cable support 15A and then pass through the second attachment opening 16G2 at the bottom end 16F of the first cable support 15A. In another instance, the one or more cables or wires “W” may pass through the first attachment opening 16G1 at the bottom end 16F of the first cable support 15A and then pass through the second attachment opening 16G2 at the top end 16E of the first cable support 15A.

The first cable support 15A may also define at least one notch 16H at the outer side 15D between the first end 16A and the second end 16B. As best seen in FIGS. 3 and 5A-5B, first cable support 15A defines a first notch 16H1 at the outer side 16D of the first cable support 15A proximate to the first end 16A of the first cable support 15A. In the present disclosure, the first notch 16H1 is also aligned with the first attachment opening 16G1. Such inclusion of the first notch 16H1 enables for one or more fasteners “F” to be supported inside of the first cable support 15A to prevent lateral movement of the one or more fasteners “F” when securing the one or more cables or wires to the first cable support 15A at the first attachment opening 16G1.

Still referring to FIGS. 3 and 5A-5B, first cable support 15A also defines second notch 16H2 at the outer side 16D of the first cable support 15A proximate to the second end 16B of the first cable support 15A. In the present disclosure, the second notch 16H2 is also aligned with the second attachment opening 16G2. Such inclusion of the second notch 16H2 also enables for one or more fasteners “F” to be supported inside of the first cable support 15A to prevent lateral movement of the one or more fasteners “F” when securing the one or more cables or wires to the first cable support 15A at the second attachment opening 16G2

Lower shank 10 also includes a leg 17 that extends downwardly from the main body 11, particularly the intermediate portion 14. As described in greater detail below, leg 17 is configured to enable various planting and seeding attachments to operably engage with leg 17, including row opening wheels of row unit 1, for creating and opening a channel in a ground surface to drop and plant seeds into the ground surface. As best seen in FIG. 8B, leg 17 includes a first or top end 17A that operably engages with the main body 11, a second or bottom end 17B that vertically opposes the top end 17A and spaced apart from the intermediate portion 14, and a vertical axis 17C defined therebetween.

In the present disclosure, leg 17 includes a first lateral wall 17D that extends downwardly from the top end 17A to the bottom end 17B at a first angle measured relative to the vertical axis 17C; the first angle is denoted by an arrow labeled “B1” in FIG. 8B. Leg 17 also includes a second lateral wall 17E that extends downwardly from the top end 17A to the bottom end 17B at a second angle measured relative to the vertical axis 17C; the second angle is denoted by an arrow labeled “B2” in FIG. 8B. As best seen in FIG. 8B, the first lateral wall 17D and the second lateral wall 17E are parallel with one another yet transversely opposite to one another. In the present disclosure, the first angle of the first lateral wall 17D and the second angle of the second lateral wall 17E are equal with one another. In one exemplary embodiment, the first angle of the first lateral wall 17D and the second angle of the second lateral wall 17E are about 7.5 degrees.

Still referring to FIG. 8B, leg 17 also includes a first securement member 17F that is provided on the first lateral wall 17D. In the present disclosure, the first securement member 17F extends outwardly from the first lateral wall 17D at a third angle measured relative to the vertical axis 17C of the leg 17; the third angle is denoted by an arrow labeled “B3” in FIG. 8B. Leg 17 also includes a second securement member 17G that is provided on the second lateral wall 17E. In the present disclosure, the second securement member 17G extends outwardly from the second lateral wall 17E at a fourth angle measured relative to the vertical axis 17C of the leg 17; the fourth angle is denoted by an arrow labeled “B4” in FIG. 8B. As best seen in FIG. 8B, the first securement member 17F and the second securement member 17G are parallel with one another yet transversely opposite to one another. In the present disclosure, the third angle of the first securement member 17F and the fourth angle of the second securement member 17G are equal with one another and are greater than the first angle of the first lateral wall 17D and the second angle of the second lateral wall 17E. In one exemplary embodiment, the first angle of the first lateral wall 17D and the second angle of the second lateral wall 17E are about 12 degrees.

Still referring to FIG. 8B, the first securement member 17F also defines a first threaded opening 17H that extends transversely into the first securement member 17F. In the present disclosure, the first threaded opening 17H is defined along a first rotational axis R1 measured relative to the vertical axis 17C of the leg 17; the first rotational axis R1 lies on the third angle of the first securement member 17F. The second securement member 17G also defines a second threaded opening 17J that extends transversely into the second securement member 17G. In the present disclosure, the second threaded opening 17J is defined along a second rotational axis R2 measured relative to the vertical axis 17C of the leg 17; the second rotational axis R2 lies on the fourth angle of the second securement member 17G.

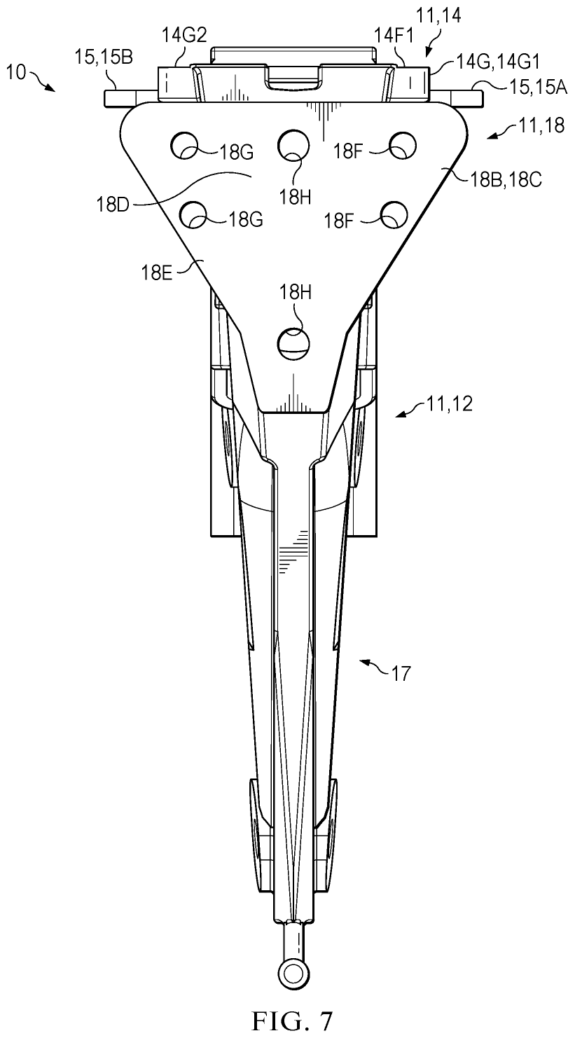

Lower shank 10 also includes a mounting portion 18 that operably engages with the main body 11, particularly the intermediate portion 14, and is positioned at the second main end 10B. As best seen in FIGS. 5A-6, mounting portion 18 includes a first end 18A that operably engages with the second end 14B of the intermediate portion 14, a second end 18B that is longitudinally opposite to the first end 18A and is positioned at the second main end 10B, and a longitudinal axis defined therebetween. In the present disclosure, mounting portion 18 also defines a triangular and/or V-shaped configuration when viewed from a front elevation view (see FIG. 7) for providing a greater area of engagement between the lower shank 10 and a head shank of the row unit 1, which is discussed in greater detail below.

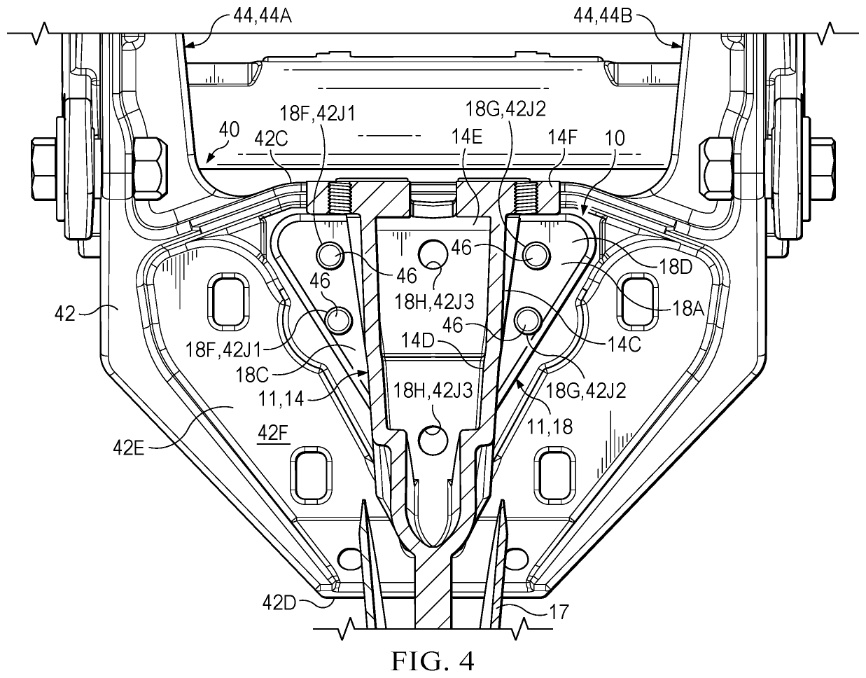

Mounting portion 18 also includes a first projection 18C. As best seen in FIGS. 4 and 8, the first projection 18C extends outwardly in a first direction from an intermediate section 18D of mounting portion 18 along an axis that is substantially perpendicular to the longitudinal axis of the mounting portion 18. In the present disclosure, the first projection 18C is positioned below and/or is offset from the upper engagement wall 14F1 of intermediate portion 14. Still referring to FIGS. 4 and 8, mounting portion 18 also includes a second projection 18E that extends outwardly in a second direction (directly opposite to the first direction of first projection 18C) from the intermediate section 18D along an axis that is substantially perpendicular to the longitudinal axis of the intermediate portion 14. In the present disclosure, the second projection 18E is positioned below and/or is offset from the upper engagement wall 14F1 of intermediate portion 14 in which the first projection 18C and the second projection 18E lie on a same horizontal plane.

Still referring to mounting portion 18, mounting portion 18 also defines a first pair of threaded openings 18F, a second pair of threaded openings 18G, and a third pair of threaded openings 18H. As best seen in FIGS. 7-8, each threaded opening of the first pair of threaded openings 18F is defined in the first projection 18C and extends entirely through the first projection 18C such that the first end 18A and the second end 18B are in fluid communication with one another at each threaded opening of the first pair of threaded openings 18F. Still referring to FIGS. 7-8, each threaded opening of the second pair of threaded openings 18G is defined in the second projection 18E and extends entirely through the second projection 18E such that the first end 18A and the second end 18B are in fluid communication with one another at each threaded opening of the second pair of threaded openings 18G. Still referring to FIGS. 7-8, each threaded opening of the third pair of threaded openings 18H is defined in the intermediate section 18D and extends entirely through the intermediate section 18D such that the first end 18A and the second end 18B are in fluid communication with one another at each threaded opening of the third pair of threaded openings 18H. Such purposes of the first pair of threaded openings 18F, the second pair of threaded openings 18G, and the third pair of threaded openings 18H are discussed in greater detail below.

Row unit 1 also includes a pair of openings disks and/or wheels 20 that rotatably engages with the lower shank 10. As best seen in FIG. 1, a first opening wheel 20A of the pair of openings wheel 20 rotatably engages with the leg 17 of the lower shank 10. Still referring to FIG. 1, a second opening wheel 20B of the pair of openings wheel 20 rotatably engages with the leg 17 of the lower shank 10. During operation, the first opening wheel 20A and the second opening wheel 20B are configured to create and/or open a channel in a ground surface to allow the row unit 1 to drop and plant seeds into the ground surface. In the present disclosure, each of the first opening wheel 20A and the second opening wheel 20B is made of a heavy duty, metal cast housing for creating and/or opening a channel in a ground surface.

Row unit 1 also includes a pair of gauge wheel arm assemblies 30 that operably engages with the lower shank 10. As best seen in FIG. 1, a first gauge wheel arm assembly 30A of the pair of gauge wheel arm assemblies 30 operably engages with the depth adjustment portion 12. Still referring to FIG. 1, a second gauge wheel arm assembly 30B of the pair of gauge wheel arm assemblies 30 operably engages with the depth adjustment portion 12. While not illustrated herein, the first gauge wheel arm assembly 30A and the second gauge wheel arm assembly 30B also operably engage with a corresponding gauge wheel from a pair of gauge wheels for setting the desired depth when cutting and/or opening a channel in a ground surface.

It should be understood that any suitable gauge wheel arm assembly described and illustrated herein may be provided with row unit 1. In one exemplary embodiment, and as presented herein, each gauge wheel arm assembly described and illustrated herein may be the gauge wheel arm assembly disclosed in U.S. Provisional Patent Application Ser. No. 63/479,284. In another exemplary embodiment, each gauge wheel arm assembly described and illustrated herein may be a conventional and/or commercially-available gauge wheel arm assembly.

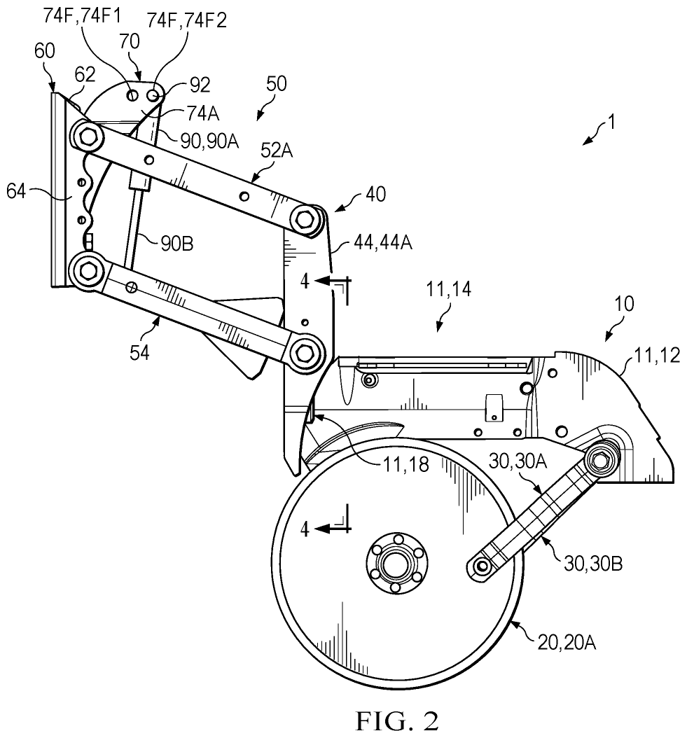

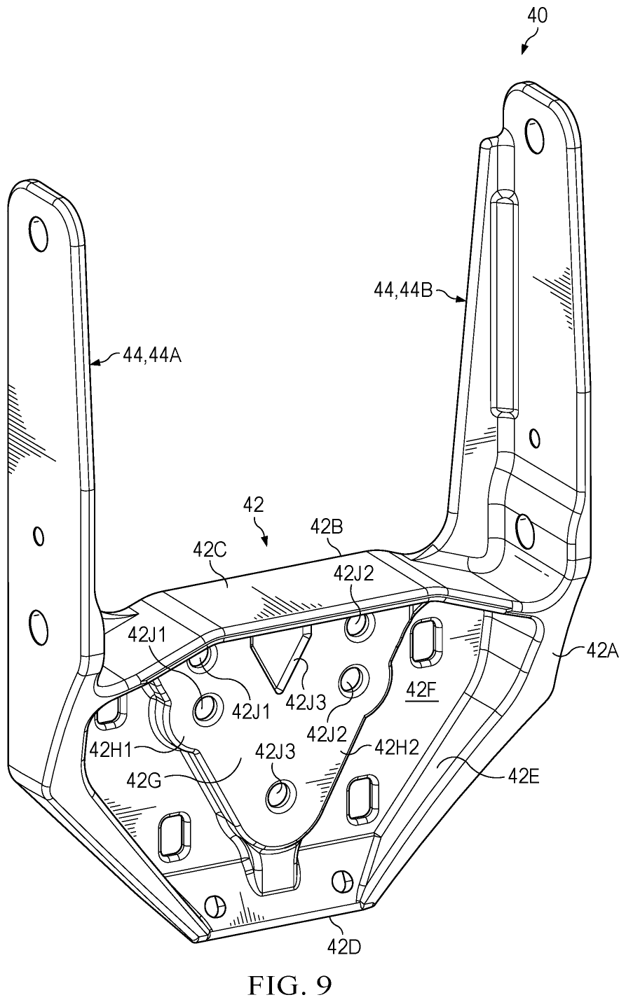

Row unit 1 may also include a head frame 40 that operably engages with the lower shank 10. As best seen in FIG. 9, head frame 40 includes a main body 42 having a first end 42A that operably engages with the second main end 10B of the lower shank 10 (see FIGS. 2 and 4), a second end 42B longitudinally opposite to the first end 42A, and a longitudinal axis defined therebetween. Still referring to FIG. 9, main body 42 also includes a top end 42C that is positioned vertically above the first end 42A and the second end 42B, a bottom end 42D that is positioned vertically opposite to the top end 42C and vertically below the first end 42A and the second end 42B, and a vertical axis defined therebetween.

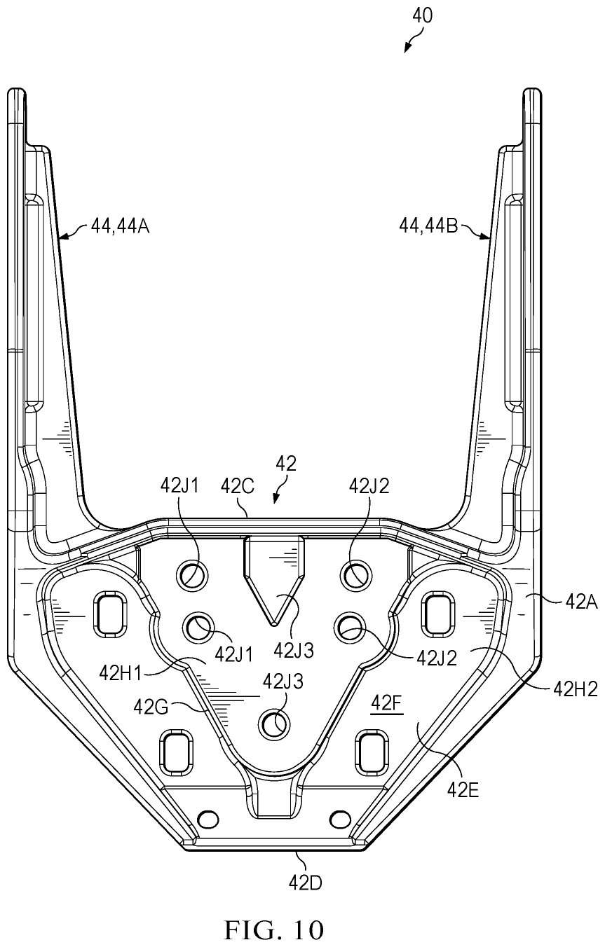

In the present disclosure, main body 42 also defines a first recess 42E that extends longitudinally into the main body 42 from the first end 42A to a first base wall 42F (see FIGS. 9-10). Main body 42 also includes a mounting surface 42G that extends outwardly from the base wall 40F towards the first end 40A inside of the first recess 42E. As seen in FIGS. 9-10, mounting surface 42G includes a first section 42H1 that defines a first pair of openings 42J1. In the present disclosure, each opening of the first pair of openings 42J1 extends entirely through the first section 42H1 such that the first recess 42E and the second end 40B are in fluid communication with one another at each opening of the first pair of openings 42J1. Similarly, mounting surface 42G includes a second section 42H2 that defines a second pair of openings 42J2. In the present disclosure, each opening of the second pair of openings 42J2 extends entirely through the second section 42H2 such that the first recess 42E and the second end 40B are in fluid communication with one another at each opening of the second pair of openings 42J2. Referring to FIG. 10, mounting surface 42G also defines a third opening 42J3 at a point where the first section 42H1 and the second section 42H2 intersect with one another and is defined vertically below the first pair of openings 42J1 and the second pair of openings 42J2. Still referring to FIG. 10, mounting surface 42G also defines a fourth opening 42J4 at a point where the first section 42H1 and the second section 42H2 bifurcate from one another and is defined vertically above the first pair of openings 42J1 and the second pair of openings 42J2.

As best seen in FIGS. 4 and 10, mounting surface 42G defines a triangular-shaped configuration and/or V-shaped configuration that matches with the triangular-shaped configuration and/or V-shaped configuration of the mounting portion 18 of lower shank 10. Upon assembly of the lower shank 10 and the head frame 40, the first pair of threaded openings 18F is coaxial with the first pair of openings 42J1, the second pair of threaded openings 18G is coaxial with the second pair of openings 42J2, and the third pair of threaded openings 18H is coaxial with the third opening 42J3 and the fourth opening 42J4. Upon alignment, a set of fasteners 46 pass through the first pair of openings 42J1, the second pair of openings 42J2, third opening 42J3, and fourth opening 42J4 and then threadably engage with the first pair of threaded openings 18F, the second pair of threaded openings 18G, and the third pair of threaded openings 18H to operably engage the lower shank 10 and the head from 40 with one another (see FIG. 4).

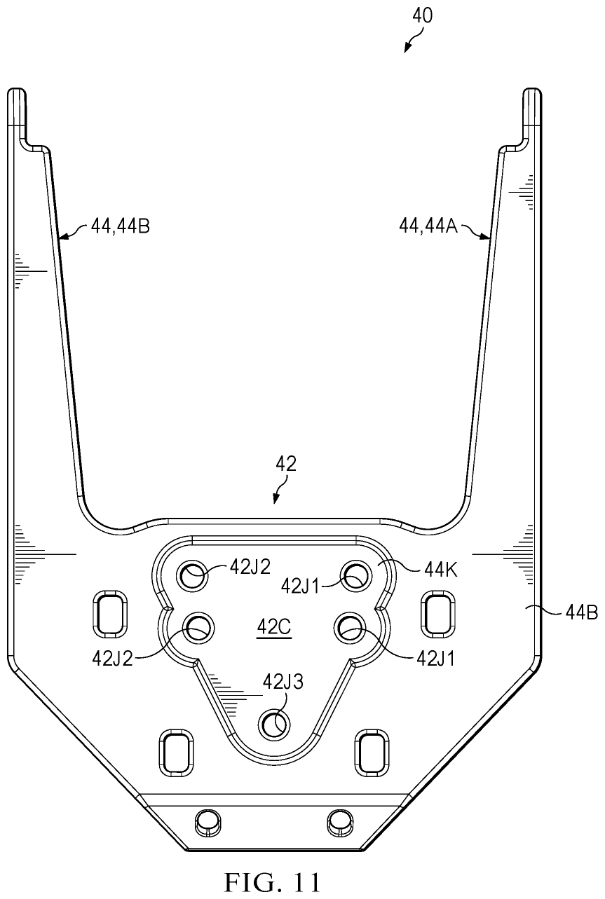

In the present disclosure, main body 42 also defines a second recess 42K that extends longitudinally into the main body 42 from the second end 42B to a second base wall 42L (see FIG. 11). Here, second base wall 42L also defines the first pair of openings 42J1, the second pair of openings 42J2, third opening 42J3, and fourth opening 42J4 to enable fasteners 46 to pass through the main body 42. While not illustrated herein, heads of fasteners 46 may be housed inside of the second recess 42K once the fasteners 46 operably engages the lower shank 10 and the head frame 40 with one another.

Head frame 40 also includes a pair of upright members 44. As best seen in FIG. 9, a first upright member 44A of the pair of upright members 44 extends vertically upward from the main body 42. Similarly, a second upright member 44B of the pair of upright members 44 extends vertically upward from the main body 42 and is positioned transversely opposite to the first upright member 44A. As discussed in greater detail below, the pair of upright members 44 is configured to operably engage with a parallel linkage system of row unit 1.

Row unit 1 also include a parallel linkage system 50 that operably engages with the head frame 40. As best seen in FIGS. 1 and 2, parallel linkage system 50 includes a first upper parallel arm assembly 52A that pivotably engages with the head frame 40, particularly with the first upright member 44A of the pair of upright members 44. Parallel linkage system 50 also includes a second upper parallel arm assembly 52B that pivotably engages with the head frame 40, particularly with the second upright member 44B of the pair of upright members 44, and is positioned opposite to the first upper parallel arm assembly 52A. In one exemplary embodiment, each of the first upper parallel arm assembly 52A and the second upper parallel arm assembly 52B may be upper short parallel arm assemblies manufactured by G.B.G.I., Inc. In another exemplary embodiment, each of the first upper parallel arm assembly 52A and the second upper parallel arm assembly 52B may be any preexisting or commercially-available upper parallel arm assemblies.

Parallel linkage system 50 also includes a lower parallel arm assembly 54 that pivotably engages with the head frame 40, particularly with the first upright member 44A and the second upright member 44B of the pair of upright members 44. In the present disclosure, the lower parallel arm assembly 54 is positioned vertically below the first upper parallel arm assembly 52A and the second upper parallel arm assembly 52B. Lower parallel arm assembly 54 also includes a lower arm 56 that has a first mount 56A positioned at the head frame 40 and a second mount 56B positioned longitudinally opposite to the first mount 56A. As discussed in greater detail below, the lower arm 56 of the lower parallel arm assembly 54 may operably engage with a piston rod of an actuator of the row unit 1 at one of the first mount 56A and the second mount 56B. In one exemplary embodiment, the lower parallel arm assembly 54 may be a lower parallel arm assembly disclosed in U.S. patent application Ser. No. 18/086,006. In another exemplary embodiment, the lower parallel arm assembly 54 may be any preexisting or commercially-available lower parallel arm assembly.

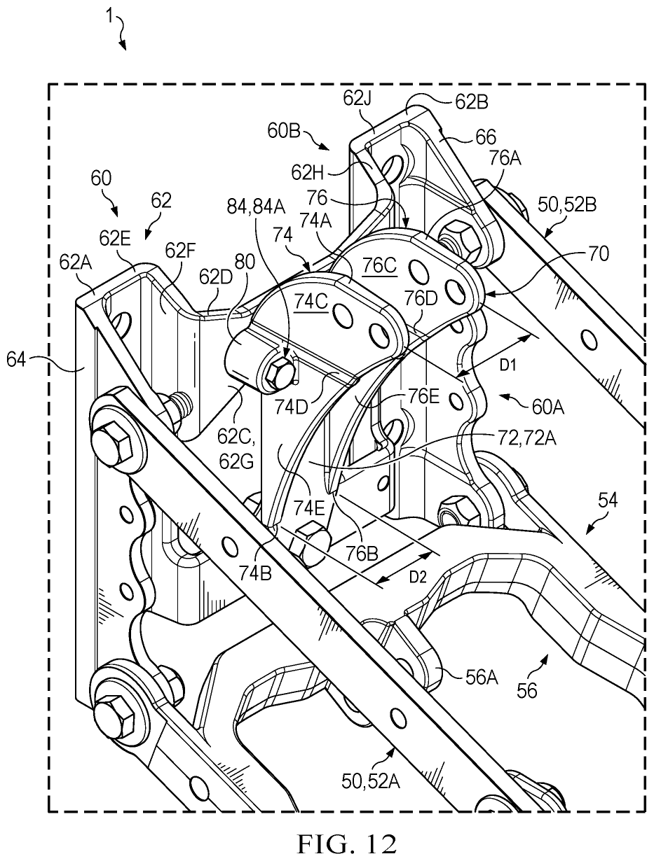

Row unit 1 may also include a mounting bracket 60. As best seen in FIGS. 1 and 12, mounting bracket 60 operably engages with the parallel linkage system 50 and is adapted to operably engage with a bar of a planter or seeding machine (not illustrated herein). As best seen in FIG. 12, mounting bracket 60 includes a first end 60A that faces towards the head frame 40, a second end 60B that faces away from the head frame 40 and is opposite to the first end 60A, and a longitudinal axis defined therebetween. Such components and features of mounting bracket 60 are discussed in greater details below.

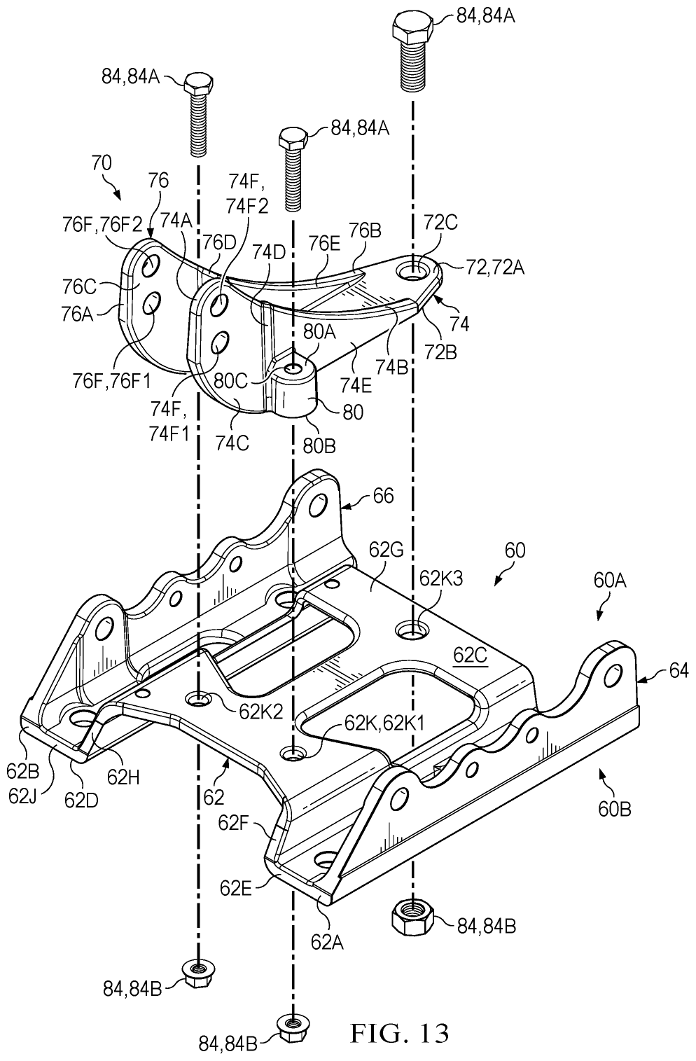

Mounting bracket 60 includes a support plate 62. As best seen in FIG. 13, support plate 62 includes a first side 62A, a second side 62B transversely opposite to the first side 62A, and a transverse axis defined therebetween. Support plate 62 also includes a first surface 62C that extends along the first surface 62C between the first side 62A and the second side 62B and faces towards the first end 60A. Support plate 62 also includes a second surface 62D that extends along the first surface 62C between the first side 62A and the second side 62B and faces towards the second end 60B in an opposite direction relative to the first surface 62C.

Still referring to FIG. 13, support plate 62 also includes a first wall 62E that extends transversely from the first side 62A towards the second side 62B. Support plate 62 also includes second wall 62F that extends rearward from the first wall 62E towards the first end 60A. Support plate 62 also an attachment plate 62G that extends transversely from the second wall 62F towards the second side 62B wherein the attachment plate 62G is offset from the first wall 62E and is closer to the first end 60A. Still referring to FIG. 13, support plate 62 also includes third wall 62H that extends forwardly from the attachment plate 62G towards the second end 60B of mounting bracket 60. Support plate 62 also includes a fourth wall 62J that extends transversely from the third wall 62H to the second side 62B where fourth wall 62J is offset from the attachment plate 62G and is closer to the second end 60B.

Support plate 62 also defines a set of apertures 62K in the attachment plate 62G. As best seen in FIG. 13, attachment plate 62G defines a first aperture 62K1 of the set of apertures 62K that is positioned near the second wall 62F. Still referring to FIG. 13, attachment plate 62G also defines a second aperture 62K2 of the set of apertures 62K that is positioned near the third wall 62H and is adjacent to the first aperture 62K1. Still referring to FIG. 13, attachment plate 62G also defines a third aperture 62K3 of the set of apertures 62K that is positioned between the second wall 62F and the third wall 62H and is positioned vertically below the first aperture 62K1 and the second aperture 62K2.

In the present disclosure, the third aperture 62K3 defines a diameter that is greater than diameters defined by the first aperture 62K1 and the second aperture 62K2. As such, the third aperture 62K3 is configured to receive a fastener and/or bolt that defines a greater diameter than the fasteners and/or bolts configured to be received by the first aperture 62K1 and the second aperture 62K2. In one exemplary embodiment, each of the first aperture 62K1, the second aperture 62K2, and the third aperture 62K3 may define a substantially similar or identical diameter for receiving a fastener and/or bolt defining substantially a similar or identical diameter.

Mounting bracket 60 also includes a pair of linkage walls that operably engages with the support plate 62. As best seen in FIGS. 12-13, mounting bracket 60 includes a first linkage wall 64 that operably engages with the support plate 62 at the first side 62A. Upon assembly, first upper parallel arm assembly 52A and the lower parallel arm assembly 54 pivotably engages with the first linkage wall 64. Mounting bracket 60 also includes a second linkage wall 66 that operably engages with the support plate 62 at the second side 62B transversely opposite to the first linkage wall 64. Upon assembly, second upper parallel arm assembly 52B and the lower parallel arm assembly 54 pivotably engages with the second linkage wall 66.

Row unit 1 also include an actuator bracket 70. As best seen in FIGS. 1 and 12, actuator bracket 70 operably engages with the mounting bracket 60, particularly with the attachment plate 62G, on the first surface 62C with at least one attachment assembly, which is discussed in greater detail below. In the present disclosure, actuator bracket 70 removably engages with the mounting bracket 60 if the actuator bracket 70 is not needed during a planting operation. In operation, actuator bracket 70 is configured to enable an actuator to pivotably engage with the actuator bracket 70 at one or more locations on the actuator bracket 70. Such components and features of the actuator bracket 70 are discussed in greater detail below.

Actuator bracket 70 includes a base plate 72 that operably engages with the mounting bracket 60. As best seen in FIG. 13, base plate 72 includes a first surface 72A that faces away from the mounting bracket 60. Base plate 72 also includes a second surface 72B that faces at the mounting bracket 60 and faces in an opposite direction relative to the first surface 72A. During assembly, the second surface 72B of the base plate 72 contacts with the first surface 62C of support plate 62 upon the base plate 72 operably engaging with the attachment plate 62G. Base plate 72 also defines a through-hole 72C that extends entirely through the base plate 72 such that the first surface 72A and the second surface 72B are in fluid communication with one another at the through-hole 72C. Upon assembly, the through-hole 72C is coaxial with the third aperture 62K3 of support plate 62 for removably engaging the actuator bracket 70 with the mounting bracket 60. Such use and purpose of the through-hole 72C is discussed in greater detail below.

Actuator bracket 70 also includes a first upright wall 74 that operably engages with the base plate 72. As best seen in FIG. 13, first upright wall 74 includes a first or top end 74A, a second or bottom end 74B that is vertically opposite to the top end 76A, and a vertical axis defined therebetween. First upright wall 74 also includes a first portion 74C that extends downwardly from the top end 74A to a bend or bent portion 74D. First upright wall 74 also includes a second portion 74E that extends downwardly from the bent portion 74D towards the bottom end 74B. As best seen in FIGS. 12-13, the first portion 74C and the second portion 74E are offset to one another by the bent portion 74D such that the second portion 74E is positioned inward of the first portion 74C.

First upright wall 74 also defines a first pair of openings 74F. As best seen in FIG. 13, the first pair of openings 74F is defined at the top end 74A of the first upright wall 74 and extends transversely through the first upright wall 74. The first pair of openings 74F includes a first opening 74F1 that is defined proximate to the base plate 72 and a second opening 74F2 adjacent with the first opening 74F1 and defined away from the base plate 72.

Actuator bracket 70 also includes a second upright wall 76 that operably engages with the base plate 72. As best seen in FIG. 13, second upright wall 76 includes a first or top end 76A, a second or bottom end 76B that is vertically opposite to the top end 76A, and a vertical axis defined therebetween. Second upright wall 76 also includes a first portion 76C that extends downwardly from the top end 76A to a bend or bent portion 76D. Second upright wall 76 also includes a second portion 76E that extends downwardly from the bent portion 76D towards the bottom end 76B. As best seen in FIGS. 12-13, and similar to the first upright wall 74, the first portion 76C and the second portion 76E are offset to one another by the bent portion 76D such that the second portion 76E is positioned inward of the first portion 76C. In the present disclosure, a first distance (denoted D1 in FIG. 12) is measured between the first portion 74C of the first upright wall 74 and the first portion 76C of the second upright wall 76, and a second distance (denoted D2 in FIG. 12) is measured between the second portion 74E of the first upright wall 74 and the second portion 76E of the second upright wall 76; the first distance is greater than the second distance due to the offset configurations of the first upright wall 74 and the second upright wall 76.

Second upright wall 76 also defines a second pair of openings 76F. As best seen in FIG. 13, the second pair of openings 76F is defined at the top end 76A of the second upright wall 76 and extends transversely through the second upright wall 76. The second pair of openings 76F includes a first opening 76F1 that is defined proximate to the base plate 72 and a second opening 76F2 adjacent with the first opening 76F1 and defined away from the base plate 72. In the present disclosure, the first opening 74F1 of the first upright wall 74 is coaxial with the first opening 76F1 of the second upright wall 76 for receiving a bolt or pivot member to pivotably engage an actuator of the row unit with the actuator bracket 70. Similarly, the second opening 74F2 of the first upright wall 74 is coaxial with the second opening 76F2 of the second upright wall 76 for receiving a bolt or pivot member to pivotably engage an actuator of the row unit with the actuator bracket 70.

Actuator bracket 70 also includes an inner wall 78 that operably engages with the first upright wall 74 and the second upright wall 76. As best seen in FIG. 3, inner wall 78 includes a first or top end 78A, a second or bottom end 78B vertically opposite to the top end 78A and operably engages with the base plate 72, and a vertical axis defined therebetween. Inner wall 78 also includes a first side 78C positioned between the top end 78A and the bottom end 78B and operably engages with the first upright wall 74, and a second side 78D positioned between the top end 78A and the bottom end 78B and operably engages with the second upright wall 76. Inner wall 78 also includes a curvilinear wall 78E that extends inwardly from the top end 78A towards the bottom end 78B and defines a slot 78F therein.

Actuator bracket 70 includes at least one attachment mount that operably engages with the mounting bracket 60. In the present disclosure, actuator bracket 70 includes a first attachment mount 80 that operably engages with the first upright wall 74. As best seen in FIG. 13, first attachment mount 80 includes a first surface 80A that faces away from the mounting bracket 60. First attachment mount 80 also includes a second surface 80B that faces at the mounting bracket 60 and faces in an opposite direction relative to the first surface 80A. During assembly, the second surface 80B of the first attachment mount 80 contacts with the first surface 62C of support plate 62 when the base plate 72 operably engages with the attachment plate 62G. First attachment mount 80 also defines a first attachment hole 80C that extends entirely through the first attachment mount 80 such that the first surface 80A and the second surface 80B are in fluid communication with one another at the first attachment hole 80C. Upon assembly, the first attachment hole 80C is coaxial with the first aperture 62K1 of support plate 62 for removably engaging the actuator bracket 70 with the mounting bracket 60. Such use and purpose of the attachment hole 80C is discussed in greater detail below.

Actuator bracket 70 also includes a second attachment mount 82 that operably engages with the second upright wall 76. As best seen in FIG. 13, second attachment mount 82 includes a first surface 82A that faces away from the mounting bracket 60. Second attachment mount 82 also includes a second surface 82B that faces at the mounting bracket 60 and faces in an opposite direction relative to the first surface 82A. During assembly, the second surface 82B of the second attachment mount 82 contacts with the first surface 62C of support plate 62 when the base plate 72 operably engages with the attachment plate 62G. Second attachment mount 82 also defines a second attachment hole 82C that extends entirely through the second attachment mount 82 such that the first surface 82A and the second surface 82B are in fluid communication with one another at the second attachment hole 82C. Upon assembly, the second attachment hole 82C is coaxial with the second aperture 62K2 of support plate 62 for removably engaging the actuator bracket 70 with the mounting bracket 60. Such use and purpose of the attachment hole 80C is discussed in greater detail below.

In the present disclosure, actuator bracket 70 operably engages with the mounting bracket 60 via a set of attachment assemblies 84. As best seen in FIG. 13, a bolt 84A of each attachment assembly of the set of attachment assemblies 84 passes through the mounting bracket 60 and the actuator bracket 70 and threadably engages with a corresponding nut 84B in each attachment assembly of the set of attachment assemblies 84 for removably engaging the actuator bracket 70 with the mounting bracket 60. Particularly, each bolt 84A of each attachment assembly of the set of attachment assemblies 84 initially passes through the base plate 72, via the through-hole 72C, the first attachment mount 80, via the first attachment hole 80C, and the second attachment mount 82, via the second attachment hole 82C, and then passes through the support plate 62, via the set of apertures 62K, to threadably engage with the corresponding nut 84B in each attachment assembly of the set of attachment assemblies 84.

Row unit 1 also includes an actuator 90. As best seen in FIGS. 1 and 2, actuator 90 includes a cylinder 90A that operably engages with the actuator bracket 70. Particularly, cylinder 90A operably engages with the actuator bracket 70, via a first linch pin 92, wherein the cylinder 90A is positioned between the first upright wall 74 and the second upright wall 76 and the first linch pin 92 operably engages with the first upright wall 74 and the second upright wall 76. In the present disclosure, the first linch pin 92 passes through the first opening 74F1 of the first upright wall 74 and the first opening 76F1 of the second upright wall 76. In one exemplary embodiment, the first linch pin 92 may also pass through the second opening 74F2 of the first upright wall 74 and the second opening 76F2 of the second upright wall 76 if desired.

Actuator 90 also includes a piston rod 90B that is operably engages with the cylinder 90A for applying force to the parallel linkage system 50. As best seen in FIGS. 1 and 2, piston rod 90B operably engages with the lower parallel arm assembly 54, via a second linch pin 94, at the first mount 56A. In one exemplary embodiment, the second linch pin 94 may also operably engage with the lower arm 56 at the second mount 56B if desired.

During operation, actuator 90 may apply force onto the parallel linkage system 50, particularly the lower parallel arm assembly 54, based on various planting and ground surface considerations, including the depth of planting a plurality of seeds, the hardness of the soil, and other various planting and ground surface considerations. In one instance, actuator 90 may be commanded to apply pushing force on the lower parallel arm assembly 54 by a processor or processing unit (not illustrated) that is configured to electrically communicate with the actuator 90. In another instance, actuator 90 may be commanded to apply a pulling force to the lower parallel arm assembly 54 by the processor.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A row planting unit, comprising:
a lower shank;
a head frame operably engaged with the lower shank;
a pair of upper planting arms pivotably engaged with the head frame;
a lower planting arm pivotably engaged with the head frame and adapted to operably engaged with an actuating device;
wherein each of the lower shank, the head frame, the pair of upper planting arms, and the lower planting arm is casted from a single metal material.

2. The row planting unit of claim 1, wherein the lower shank comprises:
a main body having a first end and a second end longitudinally opposite to the first end;
wherein a portion of the main body defines a substantially triangular cross-section between the first end and the second end.

3. The row planting unit of claim 2, wherein the main body further comprises:
at least one pair of inner walls extending between the first end and the second end and defined at a first angle measured between each inner wall of the at least one pair of inner walls; and
at least one pair of outer walls extending between the first end and the second end and defined at a second angle measured between each outer wall of the at least one pair of outer walls.

4. The row planting unit of claim 3, wherein the at least one pair of inner walls and the at least one pair of outer walls collectively defines a first portion of the substantially triangular cross-section.

5. The row planting unit of claim 4, wherein the main body further comprises:
at least another pair of inner walls extending between the first end and the second end and defined at a third angle measured between each inner wall of the at least another pair of inner walls; and
at least another pair of outer walls extending between the first end and the second end and defined at a fourth angle measured between each outer wall of the at least another pair of outer walls;
wherein the first angle is greater than the third angle and the second angle is greater than the fourth angle.

6. The row planting unit of claim 5, wherein the at least another pair of inner walls and the at least another pair of outer walls collectively defines a second portion of the substantially triangular cross-section.

7. The row planting unit of claim 1, wherein the lower shank further comprises:
a first end;
a second end longitudinally opposite to the first end; and
at least one cable support operably engaged with the lower shank;
wherein the at least one cable support is configured to support at least one cable of the row planting unit free from interfering with the lower shank.

8. The lower shank of claim 7, wherein the at least one cable support comprises:
a first end;
a second end longitudinally opposite to the first end;
an inner side operably engaged with the lower shank; and
at least one attachment point defined in the at least one cable support between the first end and the second end;
wherein the at least one attachment point enables at least one cable of the row planting unit to be supported by the at least one cable support.

9. The lower shank of claim 8, further comprising:
at least one fastener operably engaging the at least one cable with the at least one cable support at the at least one attachment point.

10. The lower shank of claim 7, further comprising:
at least another cable support operably engaged with the lower shank transversely opposite to the at least one cable support;
wherein the at least another cable support is configured to support at least another cable of the row planting unit free from interfering with the lower shank.

11. The row planting unit of claim 1, wherein the lower shank comprises:
a first end;
a second end longitudinally opposite to the first end; and
a mounting portion positioned at the second end and having a substantially triangular-shape configuration.

12. The row planting unit of claim 11, wherein the head frame comprises:
a first end;
a second end transversely opposite to the first end; and
a mounting surface positioned between the first end and the second end along a base wall inside of a recess defined in the head frame and configured to operably engaged with the mounting portion;
wherein the mounting surface has a substantially triangular-shape configuration matching the mounting portion.

13. The row planting unit of claim 12, wherein the lower shank further comprises:
a first projection of the mounting portion extending outwardly from the second end of the lower shank and engaging with the head frame; and
a second projection of the mounting portion extending outwardly from the second end of the lower shank and engaging with the head frame;
wherein the first projection and second projection directly oppose one another to define the substantially triangular-shape configuration.

14. The row planting unit of claim 13, wherein the head frame further comprises:
a first section of the mounting surface that is configured to operably engage with the first projection; and
a second section of the mounting surface from the first section and is configured to operably engage with the second projection;
wherein the first section and second section directly oppose one another to define a substantially triangular-shape configuration for the mounting surface that matches the substantially triangular-shape configuration of the mounting portion.

15. The row planting unit of claim 1, further comprising:
a mounting bracket operably engaged with the pair of upper planting arms and the lower planting arm.

16. The row planting unit of claim 1, further comprising:
a leg of the lower shank; and
a pair of opening disks rotatably engaged with the leg of the lower shank;
wherein the leg operably engages each opening disk of the pair of opening disks at an angle of about 12 degrees.

17. The row planting unit of claim 1, further comprising:
a pair of gauge wheel arm assemblies operably engaging with the lower shank, each gauge wheel arm assembly comprises:
an arm portion; and
a hub portion operably engaged with the arm portion for receiving at least two bearings that are spaced apart from one another by at least two stop portions.

18. The row planting unit of claim 1, wherein the lower planting arm comprises:
a first linkage arm;
a second linkage arm parallel with the first linkage arm;
a first bracket fixedly engaging with the first linkage arm and the second linkage arm at a first position; and
a second bracket fixedly engaging with the first linkage arm and the second linkage arm at a second position opposite to the first position;
wherein each of the first bracket and the second bracket is adapted to operably engage with an actuating device of the row unit.

19. The row planting unit of claim 18, wherein the lower planting arm further comprises:
a first mount extending outwardly from the first bracket; and
a second mount extending outwardly from the second bracket and directly facing the first mount;
wherein each of the first mount and the second mount is adapted to operably engage with the actuating device of the row unit.

20. A row planting unit, comprising:
a lower shank having a main body that includes a first end and a second end longitudinally opposite to the first end, wherein a portion of the main body defines a substantially triangular cross-section between the first end and the second end;
a head frame operably engaged with the lower shank;
a pair of upper planting arms pivotably engaged with the head frame;
a lower planting arm pivotably engaged with the head frame and adapted to operably engaged with an actuating device;
wherein each of the lower shank, the head frame, the pair of upper planting arms, and the lower planting arm is casted from a single metal material.
